(19) United States
(12) Patent Application Publication
(10) Pub. No.: US 2014/0261220 A1
(43) Pub. Date: Sep. 18, 2014

(54) Pet Shelter

(71) Applicants: Marc Trepanier, Owens Cross Roads, AL (US); James Breaux, Owens Cross Roads, AL (US)

(72) Inventors: Marc Trepanier, Owens Cross Roads, AL (US); James Breaux, Owens Cross Roads, AL (US)

(21) Appl. No.: 13/838,026

(22) Filed: Mar. 15, 2013

(51) Int. Cl. A01K 1/00

(52) U.S. Cl. CPC A01K 1/0035
USPC 119/499

(57) ABSTRACT

A pet shelter includes an a-frame with a flexible canopy disposed across the vertex of the a-frame and attached to canopy supports extending from the upper portions of frame members comprising the a-frame. A bed comprising a bed frame defining an aperture across which spans a flexible fabric forming a hammock is installed between opposing interior surfaces of the pair of the frame members.

### BACKGROUND

### Field

The present invention relates generally to a pet shelter, and particularly to a pet shelter with a canopy and a hammock supported by an A-frame structure.

### BRIEF DESCRIPTION OF THE DRAWINGS

The apparatus is described with reference to the accompanying drawings. In the drawings, like reference numbers indicate identical or functionally similar elements.

FIG. 1 is a perspective view of a first exemplary embodiment of a pet shelter;

FIG. 2 is a perspective view of a second exemplary embodiment of a pet shelter;

FIG. 3 shows an exemplary support member according to the second embodiment of FIG. 2;

FIG. 4 depicts a pair of truss members according to the second embodiment of FIG. 2;

FIG. 5 depicts the upper side of the bed according to the second embodiment of FIG. 2;

FIG. 5A is a side elevation of the bed according to the second embodiment of FIG. 2;

FIG. 5B is a plan view of the underside of the bed according to the second embodiment of FIG. 2;

FIG. 6 is a perspective view of a third exemplary embodiment of the pet shelter;

FIG. 7 illustrates frame members according to the embodiment of FIG. 6;

FIG. 8A is a perspective view of the pet shelter according to the embodiment of FIG. 6, illustrating the upward rotation of the bed;

FIG. 813 is an perspective view of the pet shelter from the opposite as that of FIG. 8A;

FIG. 8C is a side elevation of the pet shelter according to the embodiment of FIG. 6 illustrating the shelter in a collapsing condition.

### DETAILED DESCRIPTION

The various embodiments of the present invention and their advantages are best understood by referring to FIGS. 1 through 8C of the drawings. The elements of the drawings are not necessarily to scale, emphasis instead being placed upon clearly illustrating the principles of the invention. Throughout the drawings, like numerals are used for like and corresponding parts of the various drawings.

Furthermore, reference in the specification to “an embodiment,” “one embodiment,” “various embodiments,” or any variant thereof means that a particular feature or aspect of the invention described in conjunction with the particular embodiment is included in at least one embodiment. Thus, the appearance of the phrases “in one embodiment,” “in another embodiment,” or variations thereof in various places throughout the specification are not necessarily all referring to its respective embodiment.

FIG. 1 depicts a first exemplary pet shelter 100 comprising an “A-frame” 1, including two generally triangular frame members 3, 5 opposing each other perpendicularly with respect to the a-frame, upper ends of which are connected to a ridge beam 7 at the vertices of the frame members 3, 5. First and second horizontal canopy supports 2, 4 extend laterally from the upper portion of the A-frame 1. A fabric canopy 6 is disposed over the ridge beam 7 with ends 9, 11 attached to the outward edges of the canopy supports 2, 4. The lower portion of the A-frame 1 supports a bed 12 connected at four points to opposing surfaces of the frame members 3, 5. The bed 12 comprises a bed frame 14 dimensioned to be received within the width between the opposing interior surfaces of the frame members 3, 5 and is clad in a flexible fabric 15 forming a hammock. The edges of the fabric 15 are preferably attached to the bed frame 14.

A second embodiment is illustrated with reference to FIGS. 2 through 6 wherein shelter 100′ may be more easily assembled and disassembled for enhanced portability. In the illustrated embodiment, the A-frame 1 comprises two opposing frame members 23a, b, an elevation view of which is shown in FIG. 3. Each frame member 23a, b comprises a frame 21 defining an aperture and having an upper edge 22 with a pair of slots 24a, b disposed near the lateral sides of the upper edge. The frame 21 also includes opposing interior surfaces 26a, b with a pair of opposing dowels 27a, b inserted into the interior surfaces 26 near a lower portion of the frame 21.

The illustrated embodiment also comprises a pair of truss members 25a, b that tie the frame members 23a, b together to form the A-frame 1 and act as canopy supports. FIG. 4 presents elevation views of the truss members 25a, b which in this embodiment include a pair of angled slots 28a, b defined in the truss lower edge 29 and extending upward, tending toward one another. Thus, the A-frame 1 is assembled by inserting corresponding frame slots 24a, from each frame member into each angled slot 28a, b of a truss member 25, as shown in FIG. 2. Further, canopy 6′ may be attached by its lateral edges 30a, b to the top edges 31 of the truss members 25, either with adhesive, fasteners, or with Velcro, or with other means of attachment known in the art.

Lastly, bed 12′ again comprises a bed frame 14′ with a flexible fabric 15 attached to the forward and rear ends of the frame 14′. With reference now to FIGS. 5A & 5B, bed frame 12′ includes two pairs of laterally opening dowel recesses 32a, b defined in the under surface 34 of the frame 14′ at its lateral edges 33a, b. As such, once the A-frame 1 is assembled as earlier described, bed 12′ may be installed by inserting it through the frame members 23a, b and resting the bed frame 14′ upon the dowels 27a, b with the dowels received within the respective dowel recesses 32a, b.

FIGS. 6 through 8 depict yet another exemplary embodiment of the shelter 100″ including an A-frame 1 comprising opposing frame members 23a, b that are hingedly attached by respective top edges 38a, b with one or more hinges 37. Also, canopy supports 2′, 4′ are pivotally attached at their respective inward ends to the upper portions of respective frame members 23a, b, at pivot points 39a, b, with canopy 6 disposed across the a-frame 1 and having ends 9, 11 attached to the outward edges of the respective canopy supports 2′, 4′. Bed 12″ in the illustrated embodiment may be similar to that disclosed above, with the exception that the bed frame 14″ is configured with one pair of dowel recess 32, but is pivotally attached near one end to the opposing interior edges of one support member 23b at a pivot point 35. Accordingly, only one support member 23a includes opposing dowels 27 extending from opposing interior edges (FIGS. 8A &B). As with the previous example, bed frame 14″ is supported near one end by the dowels 27 being received within respective recesses 32.

As depicted in FIGS. 8A through 8C, the shelter 100″ is a collapsible shelter, where bed 12″ may be rotated upward about its pivot point 35, while the frame members 23a, b are rotated toward each other about the hinge 37. Canopy supports 2′, 4′ are rotated upward about respective pivot points 39a, b with the flexible canopy 6 folding in between them (FIG. 8C).

As described above and shown in the associated drawings, the present invention comprises a pet shelter with a canopy and hammock. While particular embodiments have been described, it will be understood, however, that any invention appertaining to the apparatus described is not limited thereto, since modifications may be made by those skilled in the art, particularly in light of the foregoing teachings. It is, therefore, contemplated by the appended claims to cover any such modifications that incorporate those features or those improvements that embody the spirit and scope of the invention.

What is claimed is:

1. A pet shelter comprising:
an a-frame having a top vertex and including a pair of frame members;
a flexible canopy disposed across the vertex and attached to canopy supports extending from an upper portion of the frame members and in parallel with the a-frame;
a bed comprising a bed frame defining an aperture across which spans a flexible fabric forming a hammock, said bed installed between opposing interior surfaces of the pair of the frame members.

2. The pet shelter of claim 1, wherein each of the frame members comprises a frame defining an aperture with a pair of opposing dowels extending from the opposing interior surfaces thereof.

3. The pet shelter of claim 2, wherein said bed frame further comprises two pairs of recesses defined in an under surface of said frame and oriented to receive said dowels.

4. The pet shelter of claim 3, further comprising:
a pair of truss members, each having a pair of downward opening angled slots;
and a pair of slots defined in upper edges of said support member frames and disposed at either end thereof; and
wherein corresponding slots of said opposing frame members are received within the pair of downward opening angled slots of the truss members.

5. The pet shelter of claim 4, wherein said canopy is attached to a top edge of said truss members.

6. The pet shelter of claim 1, wherein the frame members comprise first and second frame members, said frame members comprising a generally rectangular frame, said first support member comprising a pair of opposing dowels extending from said opposing interior surfaces thereof.

7. The pet shelter of claim 6, wherein said bed frame comprises one pair of recesses defined in an under surface of said bed frame near a first end of said bed frame, and is pivotally attached near a second end to said opposing interior surfaces of said second support member.

8. The pet shelter of claim 7, wherein said first and second frame members are hingedly attached at their respective top edges.

9. The pet shelter of claim 8, wherein said canopy supports have opposing ends pivotally attached to said opposing interior surfaces of said frame members.
